(19) United States
(12) Patent Application Publication
(10) Pub. No.: US 2003/0090666 A1
(43) Pub. Date: May 15, 2003

(54) Gas permeable probe for use in an optical analyzer for an exhaust gas stream flowing through a duct or chimney

(75) Inventor: Juergen Kaufmann, Denzlingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SICK AG, Waldkirch (DE)

(21) Appl. No.: 10/054,119

(22) Filed: Nov. 13, 2001

(51) Int. Cl. G01N 21/61

(52) U.S. Cl. 356/438

(57) ABSTRACT

A gas permeable probe for use in an optical analyzer for an exhaust gas stream flowing through a duct or chimney comprises:

an elongate hollow structure having first and second ends and a side wall, with an optical cavity defined between said first and second ends within said side wall,

a mounting structure at said first end and adapted for mounting said elongate hollow structure within said duct or chimney,

a support member at said second end,

a connecting structure connecting said mounting flange at said first end to said support flange at said second end,

an optical window at said first end permitting a beam of light originating from an optical analyzer to enter into said optical cavity to travel from said first end to said second end,

a retroreflector provided at said second end for returning said light beam to said first end of said hollow structure,

an elongate filter module forming part of said elongate hollow structure, having first and second opposite ends and comprising a filter structure including at least one filter member and a bellows at one of said first and second opposite ends adjacent said filter structure,

said elongate filter module being connectable at its first end to said mounting structure and at its second end to said support member.

### FIELD OF THE INVENTION

The present invention relates to a gas permeable probe for use in an optical analyzer for an exhaust gas stream flowing through a duct or chimney, the probe comprising:

an elongate hollow structure having first and second ends and a side wall, with an optical cavity defined between said first and second ends within said side wall,

a mounting structure at said first end and adapted for mounting said elongate hollow structure within said duct or chimney,

an optical window at said first end permitting a beam of light originating from an optical analyzer to enter into said optical cavity to travel from said first end to said second end,

a retroreflector provided at said second end for returning said light beam to said first end of said hollow structure,

a filter structure forming a part of said side wall and including at least one filter having a pore size and adapted to permit a gas passing through said duct or chimney to enter into said optical cavity but to prevent particulate matter having particle sizes larger than said pore size from entering said optical cavity.

A gas permeable probe of this kind is known, for example, from U.S. Pat. No. 4,560,873. The gas permeable probe disclosed in this reference utilizes a cylindrical ceramic filter to permit gas flowing through the chimney to enter into the optical cavity, with the pores of the filter being sized such that particulate material in the chimney is prevented from entering the optical cavity. A similar gas permeable probe is disclosed in U.S. Pat. No. 6,064,488 in which the elongate hollow structure comprises a tube having slots relieved in the upper and lower surfaces thereof with filters of sintered metal being welded into the windows to allow gas flowing through a chimney to enter into the optical cavity. The porosity, area and location of the filters in the known arrangements determines the rate that gas diffuses through the optical cavity. Gas permeable probes of the above kind are used in optical analyzers designed to carry out spectral analysis of gases contained in the optical cavity. Since the gases contained in the optical cavity correspond to the gases flowing through the duct or chimney it is possible, using a spectral analysis, to obtain information on the types of gas that are present in the duct or chimney and their relative concentrations.

Moreover, a gas permeable probe of this kind can also be used to obtain information on various types of dust and dust contents in gas flows such as exhaust streams. This can be done if the pore size of the filter is selected such that the dust of interest can enter into and escape from the optical cavity.

Gas permeable probes of the kind to which the present application relates can to used in gas carrying ducts, especially exhaust ducts of all kinds which operate in a temperature range of e.g. 50° C. to 450° C. Such ducts are, for example, found in power stations, refuse burning plants, in cement works, in association with large furnaces, in steelworks and in gasworks.

### OBJECTS OF THE INVENTION

While known gas permeable probes of the initially named kind are suitable for certain applications, they all suffer from various restrictions, so that it is difficult to use one basic type of apparatus for a variety of different measurements and applications. For example, different applications require different types of filters with different characteristics, such as pore size and hydrophobic characteristics.

Accordingly, it is an object of the present invention to provide a gas permeable probe in which the filter can be readily changed to permit ready adaptation of a basic design of probe to different applications.

In addition, it is frequently required to carry out measurements at greatly varying temperatures and/or with different operating pressures within the duct or chimney. Known gas permeable probes are not, however, usually designed to enable operation at different temperatures within a wide temperature range or at different pressures within a wide pressure range.

Accordingly, it is an object of the present invention to provide a gas permeable probe of the above named kind which can be operated at different temperatures within a wide temperature range and at different pressures within a wide pressure range.

Furthermore, it is frequently necessary, depending on the type of measurement that has to be carried out, to use optical windows and retroreflectors of different materials, i.e. of materials having different optical characteristics. Accordingly, it is desirable to be able to relatively easily change the optical window and the retroreflector to enable adaptation of a basic gas permeable probe to different applications. Known gas permeable probes do not, however, permit this as easily as is desired. Accordingly, it is a yet further object of the present invention to provide a gas permeable probe in which the optical window and retroreflector can be readily interchanged or replaced without experiencing difficulties with the alignment of the retroreflector relative to the optical window.

It is a further object of the present invention to provide a type of modular design of a gas permeable probe which can be adapted in a relatively simple manner for use for a wide range of applications with respect to the gas temperature, gas pressure, water content, gas concentration, type of gas and with respect to the most diverse types of dust and dust contents, and which, at the same time, operates reliably over a long period of time in a simple manner with a low servicing requirement and which can be calibrated with respect to the gases being detected without sources of error.

### BRIEF SUMMARY OF THE INVENTION

In order to satisfy these objects there is provided a gas permeable probe for use in an optical analyzer for an exhaust gas stream flowing through a duct or chimney, the probe comprising:

an elongate hollow structure having first and second ends and a side wall, with an optical cavity defined between said first and second ends within said side wall,

a mounting structure at said first end and adapted for mounting said elongate hollow structure within said duct or chimney,

an optical window at said first end permitting a beam of light originating from an optical analyzer to enter into said optical cavity to travel from said first end to said second end,

a retroreflector provided at said second end for returning said light beam to said first end of said hollow structure,

a filter structure forming a part of said side wall and including at least one filter having a pore size adapted to permit a gas passing through said duct or chimney to enter into said optical cavity but to prevent particulate matter having particle sizes larger than said pore size from entering said optical cavity,

a bellows disposed between one of said first and second ends and said filter structure and

a connecting structure connecting said mounting structure at said first end to a support member or flange for said retroreflector at said second end.

The connecting structure connecting the mounting structure at said first end to the support member for the retroreflector at the second end ensures that the retroreflector is always correctly aligned with the optical window provided at the first end. Because the connecting structure is usually made of a metal, such as stainless steel, whereas the filter structure consists of a different material, for example either a ceramic structure or a sintered metal, the operation of the device at different temperatures within a wide temperature range means that differential thermal expansion has to be considered and the bellows disposed between one of said first and second ends of said elongate hollow structure and said filter structure permits differential thermal expansion to occur without placing unnecessary stress on any of the components. Moreover, the presence of the flexible bellows, which can be regarded as a type of spring, also provides compensation for any tolerances or misalignment that may be present at the first and second ends of the elongate hollow structure, e.g. non-planarity or slight axial offset of mounting faces at the first end and at the second end. Thus, if the mounting faces for the filter structure at the mounting structure and support member are not strictly parallel to one another, or if a similar problem exists with respect to the ends of the filter structure, then the flexible bellows compensates for any misalignment which exists and ensures that a sealed connection is nevertheless possible between the filter structure and the mounting structure and the support members.

In addition, the design makes it possible to readily exchange the retroreflector, which is mounted on the support member without it being necessary to disturb the filter. Moreover, the optical window can be readily exchanged after removal of the filter structure.

In order to vary the effective length of the optical cavity, it is possible to arrange for the light to be transmitted backwards and forwards through the optical cavity a plurality of times and thus to increase the optical path length in the cavity by this technique. Thus, in a basic embodiment of the invention, the optical window at the first end of the hollow structure can be adapted to transmit out of the optical cavity, back to the optical analyzer, substantially all light returned to said first end by said retroreflector at said second end. The effective length of the optical cavity is then twice the distance between the optical window and the retroreflector.

Alternatively, the optical window at the first end can be adapted to reflect a first portion of the light returned to said first end by said retroreflector back to said retroreflector to obtain a multiple beam path within said optical cavity and to transmit a second portion of said light out of said optical cavity. This can, for example, be realised by providing a partially reflecting coating on said lens. This technique can be used to increase the effective length of the optical cavity.

As a further alternative, the optical window can be supplemented by a reflector disposed adjacent to it at said first end for returning light returned by said retroreflector back to said retroreflector at least once prior to said light falling on said optical window for transmission out of the optical cavity. In this way, a multiple beam path is also obtained within said optical cavity.

The mounting structure preferably comprises a first mounting flange at the first end of the elongate hollow structure. This first mounting flange provides a simple way of releasably mounting the optical window and the filter structure.

The connecting structure preferably comprises a plurality of tie members secured to said first mounting flange at said first end and to said support flange at said second end. This design allows open windows to be provided between the tie members. The filter structure can then be removed sideways from the connecting structure through the open windows so that a change of filter structure does not involve substantial dismantling of the gas permeable probe.

In a particularly preferred embodiment the gas permeable probe further comprises a support tube connected to said first mounting flange and extending to a second mounting flange adapted for mounting to a wall of said duct or chimney. This enables the optical cavity to be mounted within the duct or chimney away from the wall of the duct or chimney, and thus in a position in which it is fully exposed to the flow through the duct or chimney, without the measurement being disadvantageously affected by boundary layer wall effects of the duct or chimney. In a design of this kind, the gas permeable probe preferably further comprises an inner tube extending between the first mounting flange and the second mounting flange, with the inner tube defining an optical path of known characteristics between the first and second mounting flanges. The inner tube is, in an arrangement of this kind, sealed at the one end by the optical window and at the other end by a further optical window, so that the space within the inner tube cannot be contaminated, either by gases flowing through the duct or chimney or as a result of external effects. The inner tube may be evacuated or alternatively it can contain a neutral gas or a neutral gas mixture, i.e. a gas or gas mixture which does not or at least does not substantially impair a measurement carried out using the gas permeable probe.

In a simple embodiment the first mounting flange can be adapted for the attachment of an optical transmitter or receiver unit of an optical analyzer to the gas permeable probe, i.e. the support tube and inner tube can be dispensed with. An arrangement of this kind may be of advantage when the cross-sectional dimension of the duct or chimney is relatively small and/or when it is desired to maximise the optical path length within the optical cavity having regard to the space available.

Alternatively, if a support tube and inner tube is used, the second mounting flange can be adapted for the attachment of an optical analyser to the gas permeable probe.

In a particularly preferred embodiment the inner tube extends through the second mounting flange to a third mounting flange provided for the attachment of an optical transmitter and receiver unit of the optical analyser to the gas permeable probe. In an arrangement of this kind, a housing can be provided between the second and third mounting flanges and can contain various items, such as a power supply for heaters associated with the optical window and the retroreflector, electronic circuitry for regulating the heating power supplied, and evaluation circuits for measuring the gas temperature and the pressure at or within the optical cavity. Provision can be made for connecting such items of circuitry via a common bus to a microprocessor provided for control of the optical transmitter and receiver unit and for the analysis of the measurements. Such a microprocessor can be provided at a location remote from the duct or chimney.

The gas permeable probe further comprises at least one sensor line, at least one gas conducting line and at least one electrical lead, with said at least one sensor line and said at least one gas conducting line and said at least one electrical lead being directed through an intermediate space formed between the support tube and the inner tube. An arrangement of this kind ensures that volatile substances emitted from the lines or leads do not lead to contamination of the optical cavity and thus do not affect the quality of the measurement. Moreover, the lines and leads are hereby protected from the heat and possibly corrosive conditions prevailing in the duct or chimney.

When the sensor line is a temperature sensing line for sensing an operating temperature in the region of the optical cavity, it conveniently extends into a tube provided outside of the filter structure and terminates, for example, at a thermo-couple, in the region of the outer surface of the filter structure. A second temperature sensing line can also be provided to ensure both temperature sensors are working correctly, which can be assumed if both temperature sensing lines indicate the same or closely similar temperatures.

In addition, a pressure sensing line is preferably provided for sensing an operating pressure in the region of the optical cavity, i.e. the pressure in the duct or chimney, which can be assumed to be substantially equal to the pressure within the optical cavity.

The gas conducting line conveniently has an outlet in the optical cavity for directing a calibration gas into the optical cavity. It can also be used to direct a neutral gas or a neutral gas mixture into the optical cavity. Moreover, the gas conducting line can be used to direct a pressurized gas into the optical cavity to clean the filter of particulate material adhering to the outside of the filter.

The gas conducting line preferably extends outside of the elongate hollow structure to an orifice provided in the optical cavity at the second end of the elongate hollow structure.

The gas conducting line preferably comprises an inbuilt structure, such as a coil spring wrapped around a rod, to ensure turbulence of the calibration gas and contact of this gas with an outer wall of the gas conducting line. In this way, the calibration gas is heated to a temperature at least substantially equal to the temperature prevailing in the optical cavity, so that calibration checks can be made at the same temperature which prevails in the duct or chimney during the actual measurement. This improves the quality of calibration.

The filter structure preferably comprises a tube of filter material having first and second ends, with a filter mounting tube at said first end and a filter support tube at said second end, said filter mounting tube being connected to said bellows and said filter support tube being connected to said support member. This is a convenient design for the tubular filter structure which enables it to be readily connected to the bellows at one end and to the support member for the retroreflector at the other end, and indeed irrespective of whether the filter material is a sintered metal or a ceramic filter. In both cases the filter material can be provided with a hydrophobic coating, such as a coating of PTFE, to endow it with hydrophobic properties, which can be useful when the gas permeable probe is used in a low temperature duct or environment when water is present in liquid form and is to be excluded from the optical cavity. Although it is considered preferable to use a filter structure comprising a tube of filter material, it is also possible to use a filter structure comprising a metal tube having windows therein which are occupied by elements of filter material.

### BRIEF DESCRIPTION OF THE SEVERAL VIEWS OF THE DRAWINGS

Further advantages of the invention will be set forth in the subsequent description given with reference to the preferred embodiments as illustrated in the drawings in which are shown:

FIG. 1 a schematic axially sectioned view of a gas permeable probe in accordance with the present invention, with the section shown corresponding to the section plane I-I in FIGS. 4 to 7,

FIGS. 1A-1C sequential axial sections of the representation of FIG. 1 to an enlarged scale,

FIG. 2 a section to a further enlarged scale of the gas permeable probe of the invention in the region of the optical window and the bellows at an orientation around the longitudinal axis corresponding to the section plane II-II in FIG. 6,

FIG. 3 a section corresponding to FIG. 1C but to a further enlarged scale restricted to the region of the retroreflector.

FIGS. 4 to 7 shows cross-sections through the gas permeable probe of FIG. 1 in accordance with the section plane IV-IV, V-V, VI-VI and VII-VII respectively.

### DESCRIPTION OF THE PREFERRED EMBODIMENT

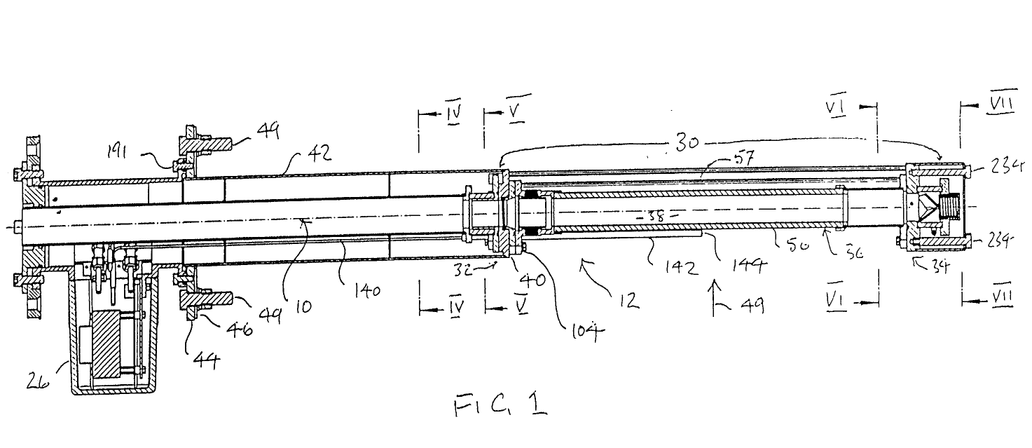

Turning first of all to FIG. 1, there can be seen an axial section along the axis 10 of a gas permeable probe indicated generally by the reference numeral 12. FIGS. 1A, 1B and 1C then show three sequential sections of the representation of FIG. 1 to an enlarged scale. The three sections of FIGS. 1A, 1B and 1C have been formed such that the position 14 at the right-hand end of FIG. 1A corresponds to the position 14 at the left-hand end of FIG. 1B and such that the position 16 at the right-hand end of FIG. 1B corresponds to the position 16 at the left-hand end of FIG. 1C.

The gas permeable probe 12 is used with an optical analyzer indicated generally by the arrow 18, which is only schematically illustrated at the left-hand end of FIG. 1A but not in FIG. 1. The optical analyzer 18 comprises a light emitter and receiver 20, a transceiver located at the left-hand end of the gas permeable probe 12 and an electrical evaluation circuit 22 which is disposed remote from the transceiver 20 in this example but which could also be combined with it. The optical analyzer includes power supplies and other items disposed within the housing 26 as will be explained later in more detail. The optical analyzer can be of any known design.

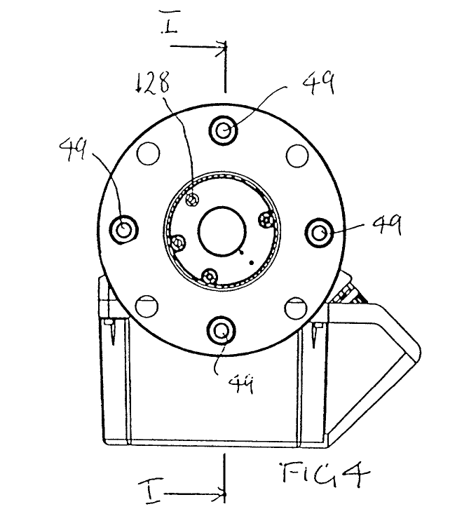

The gas permeable probe of the present invention comprises an elongate hollow structure identified generally by the reference numeral 30 in FIGS. 1B and 1C. The elongate hollow structure 30 has a first end 32 which can be seen in FIG. 1B and a second end 34 identified in FIG. 1C. The elongate hollow structure 30 has a side wall indicated generally at 36 and a hollow optical cavity 38 is defined between said first and second ends 32, 34 within said side wall 36. A mounting flange 40 is provided at the first end 32 and forms part of a mounting structure including a support tube 42 and a second mounting flange 44 and adapted for mounting the elongate hollow structure 30 to the wall 46 at one side of a duct 48. This connection is effected by bolts 49 which engage into nuts 51 mounted on a ring 53 fixed to the inside of the duct. A support member 55 provided at the second end 34 of the elongate hollow structure is permanently connected to the first mounting flange 40 by a connecting structure comprising two tie members 57 of which only one can be seen in FIG. 1. Both members 57 are shown in FIG. 6.

The gas permeable probe is thus arranged in the duct 48 for carrying out measurements on a gas stream flowing through the duct in the general direction of the arrow 49. An optical window 50 is provided at the first end 32 of the elongate hollow structure 30 and permits a beam of light (not shown) originating from the transceiver 20 to enter into the optical cavity 38 to travel in a direction generally along the longitudinal axis 10 from the first end 32 to the retroreflector 52 provided at the second end 34 of the elongate hollow structure on the support member 55. The elongate hollow structure includes a filter structure identified generally by the reference numeral 54 which includes, in this embodiment, a tube 56 of filter material having first and second ends 58, 60. The end 58 of the tube 56 of filter material is connected, for example by brazing, to a filter mounting tube 62 and the second end of the tube 56 of filter material is connected to a filter support tube 64. This connection can again be effected by brazing. The tube 56 of filter material can either be a filter of sintered metal or a filter of ceramic material and in either case it is possible to find a braze which is suitable for connecting the two ends 58 and 60 of the tube of filter material to the metallic filter mounting tube 62 and to the metallic filter support tube 64.

Alternatively, these connections can be formed as screw connections, or as adhesively bonded connections, or as interference connections. Irrespective of the type of connection used, it is convenient for the respective first and second ends 58 and 60 of the tube of filter material 56 to be received in ring recesses 66 and 68 provided in the right-hand end of the filter mounting tube 62 and in the left-hand end of the filter support tube 64 respectively.

The left-hand end of the filter mounting tube 62 in FIG. 1B is connected via a flexible metal bellows 70 to a connection flange 72 at the left-hand end of the tubular filter structure 54 in FIG. 1B and a similar connection flange 74 is provided at the right-hand end of the filter support tube 64 in FIG. 1C. The flexible metallic bellows 70 is connected at its two axial ends to the metallic connection flange 72 and to the filter mounting tube 62 by welding or brazing and the filter support tube 64 is connected to the connection flange 74 by a welded joint indicated in the usual way by a triangular fillet 76 in FIG. 1C. The connection flanges 72 and 74 are both of generally rectangular shape with rounded ends, as can be seen from FIG. 6 for the connection flange 74.

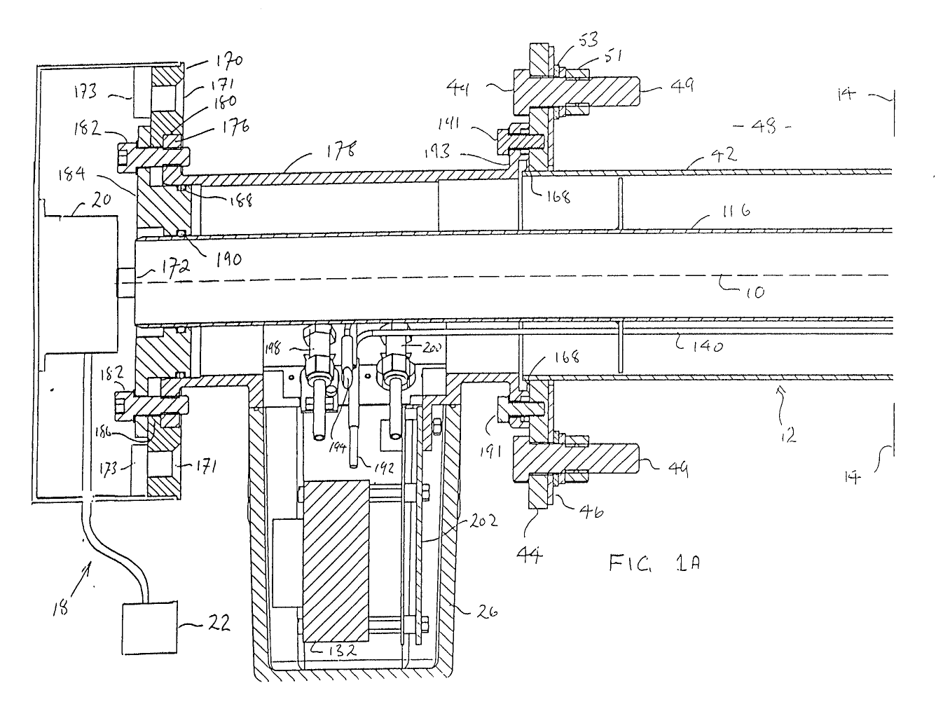

Disposed between the connection flange 72 and the mounting flange 40 is a pressure ring 78 which has a ring-like projection 80 for trapping the optical window 50 between itself and the base of a ring recess 82 provided at the mounting flange 40. A ring groove 84 is provided in the right-hand end face of the pressure ring 78 and accommodates a graphite seal 86 which is compressed when the assembly is bolted together by bolts, such as 88, as can be seen from FIG. 2. A resilient ring seal 83 is provided in a ring groove 85 at the base of the ring recess 82 between the optical window 50 and the ring recess 82. A second ring seal 87 is provided between the ring projection 80 and the optical window 50, in a ring groove 89 in the ring projection 80. These resilient ring seals 83, 87 ensure that the optical window 50 is sealed with respect to both the mounting flange 40 and with respect to the pressure ring 78 and thus with respect to the elongate hollow structure 54. At the same time they ensure that the optical window 50 is not damaged by mechanical pressure exerted between the pressure ring 78 and the mounting flange 40. A graphite seal is provided in a ring groove 79 in the pressure ring 78 to effect a seal between the pressure ring and the connection flange 72.

Within the connecting flange 72 and the flexible metallic bellows 70 there is located a sleeve 90. The sleeve 90 is only located at one end 91, between a circlip 93 and a ring shoulder 95 in order that differential thermal expansion and contraction and resilient deflection of the bellows can take place without this affecting the sleeve.

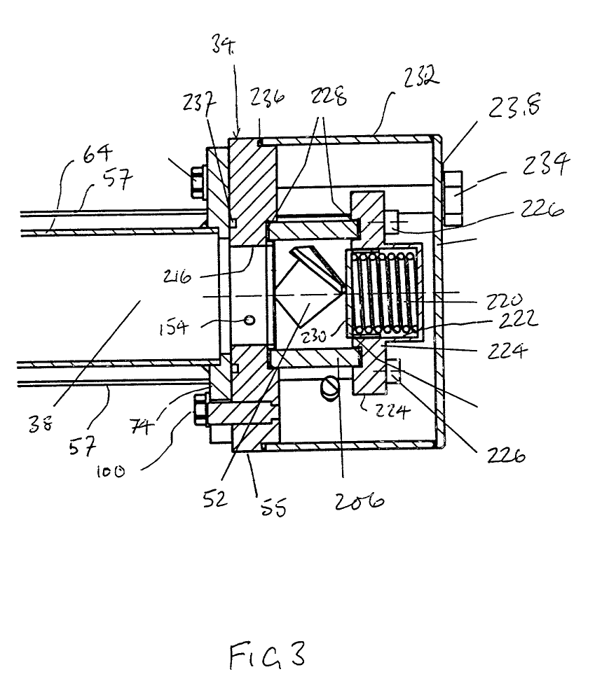

It will be noted from FIGS. 1B and 1C in conjunction with FIG. 6 hat the filter module assembly 54 comprising the connection flange 72, the flexible bellows 70, the filter mounting tube 62, the tube of filter material 56, the filter support tube 64 and the connecting flange 74 can be removed from the gas permeable probe by releasing the screws 88 and also the further screws 100 provided at the second end of the elongate hollow structure, which connect the flange 74 to the support member 55. Following the release of the screws 88 and 100 the filter module 54 can be slid sideways, i.e. at right angles to the axial direction 10 out of the assembly, as indicated by the arrow 102 in FIG. 6. The reference numerals 104 and 106 refer to radial slots provided in the connecting flange 72 and in the connecting flange 74 which allow the flange to be passed over a tube 142 which serves for the orientation of the filter module assembly 54 when it is inserted and acts as a stop to ensure it is correctly positioned. At the left-hand side of the mounting flange 40 in FIGS. 1B and 2 there is provided a connecting member 112 which serves for the connection to a mating flange 114 provided at the right-hand end of an inner tube 116 provided coaxially within the support tube 42. This connection is effected by three bolts 115 of which only one is shown in FIGS. 1 and 1B, but which can all be seen in FIG. 5.

The connecting member 112 has an axially projecting sleeve portion 124 which serves to carry a ring-like heater 125 mounted on it and trapped between it and the mating flange 114. The ring-like heater 125 is connected via leads (not shown) to a terminal block 126 provided within the support tube 42 on the mating flange 114, as can be seen from the sectioned drawing of FIG. 2. The terminal block 126 is connected via an electrical lead 128 enclosed within a protective tube 130 extending in the space between the support tube 42 and the inner tube 116 to the power supply 132 provided in the housing 26 shown in FIG. 1A. The purpose of the ring-like heater 124 is to heat the optical window 50, so that at low operating temperatures and with moist gases in the duct or chimney 48 condensation at the optical window 50 is avoided. For this purpose, the temperature of the optical window 50 is held at a temperature above that of the local environment.

Referring also to FIGS. 1A, 1B and 2 the reference numeral 140 refers to a thermocouple lead which extends in the inner space between the support tube 42 and the inner tube 116 and enters into a protective metallic tube 142 shown in FIG. 1B which terminates at a thermocouple 144 at the right-hand end of FIG. 1B. The thermocouple 144 thus measures the temperature in the duct 48 directly adjacent the surface of the tube of filter material 56 and this temperature can be considered substantially equal to the temperature prevailing in the optical cavity 38. Although not shown in FIGS. 1A and 1B, this tube 142 can also extend through the intermediate space 144 between the support tube 42 and the inner tube 116.

It can also be seen from FIG. 1A that the support tube 42, which is welded to the second mounting flange 44 at the fillet weld 168, terminates essentially at the second mounting flange 44, whereas the inner tube 116 is extended beyond the second mounting flange 44 to a third mounting flange 170 provided at the left-hand end of FIG. 1A. This third mounting flange 170 serves for the attachment of transceiver 20 to the apparatus. This is achieved by screws (not shown) which extend through countersunk bores 171 in the third mounting flange into bores provided in lugs 173 of the transceiver housing. The left-hand end of the inner tube 116 terminates at a window member 172 which does not affect, or at least substantially, does not affect light of the wavelength or wavelengths used for the spectral analysis.

It will be noted that the third mounting flange 170 is connected to a connection flange 176 at the end of a carrier tube 178, which engages into a ring recess 180 in the third mounting flange 170. This connection is effected by means of bolts 182 which pass through a disc member 184 shaped to trap a radially inwardly projecting flange 186 of the third mounting flange 170 between itself and the connection flange 176. The disc member 184 has two O-rings 188, 190 in order to seal the joint between itself and the carrier tube 178 and between itself and the inner tube 116 while permitting relative thermal expansion between the components, which can be taken up by axial sliding between the ring seal 188 and the carrier tube 178 and between the ring seal 190 and the inner tube 116.

The carrier tube 178 is in turn bolted to the second mounting flange 44 by bolts 191 extending through a further connection flange 193 into the second mounting flange. In addition to containing the power supply 132, the housing 26 also contains a connection 192 to the lead 140 leading to the thermocouple 144, a connection 194 to a second thermocouple lead 196 as well as a connection 198 to a pressure transducer provided in the optical cavity and a connection 200 for a tube or line 201 (FIG. 6) for supplying gas to the optical cavity. Since the connection to the line for supplying gas to the optical cavity can be used to supply either a calibration gas, or a neutral gas, or a gas used to purge the optical cavity and to clean particulate material from the outside of the tube 56 of filter material, valves (not shown) are provided which allow the respective gases to be admitted to the line 201 as required and which also permit the tube to be isolated relative to the material of the housing, so as to prevent flue gases entering into the housing when no gases are being supplied to the optical cavity via the line 201.

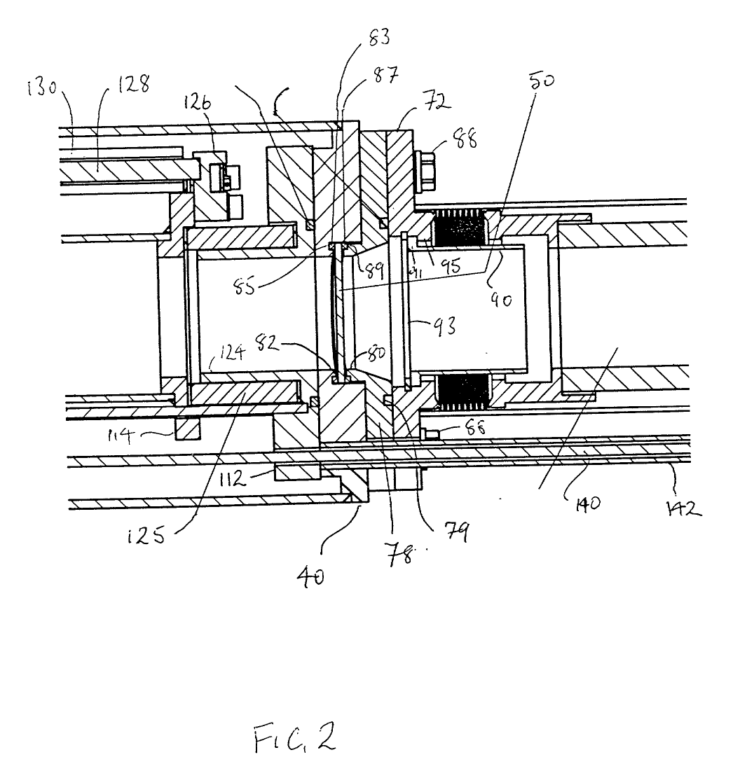

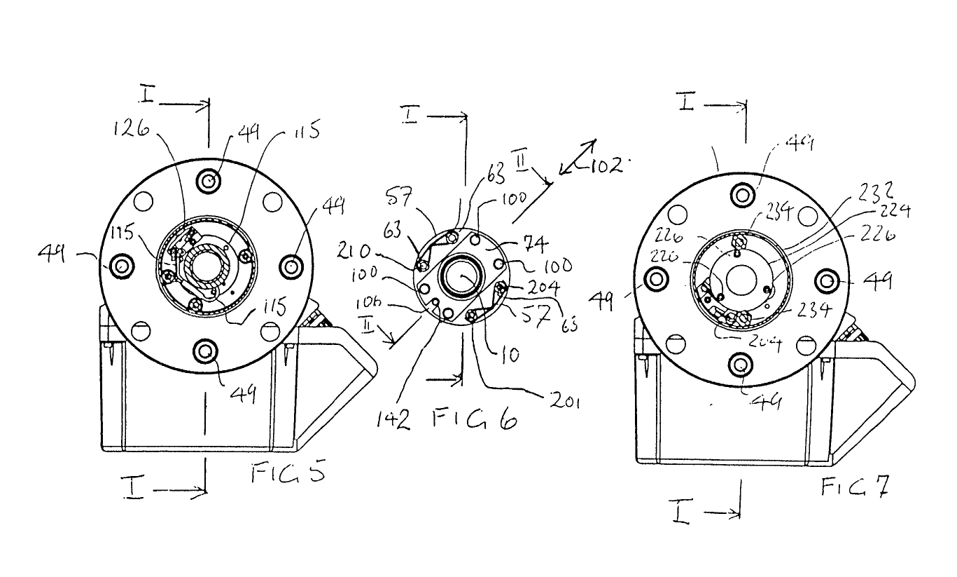

In addition to these items, the housing conveniently contains a circuit board 202 having circuits (not shown) mounted thereon for regulating the supply of electrical energy via the line 128 to the ring heater 125 associated with the optical window 50 and via a line 204 (not shown in FIG. 1A but in FIGS. 1C, 3, 4, 5, 6, and 7) to the similar ring heater 206 associated with the retroreflector 52. These regulating circuits are designed to regulate the supply of electrical energy to the respective ring heaters 125, 206, taking account of the temperature prevailing in the duct, as measured by the thermocouple 144, and thus taking account of the cooling or heating effect of the gases passing through the duct, so as to maintain temperatures of the optical window and of the retroreflector, which can be preset temperatures, sufficient to ensure condensation does not occur.

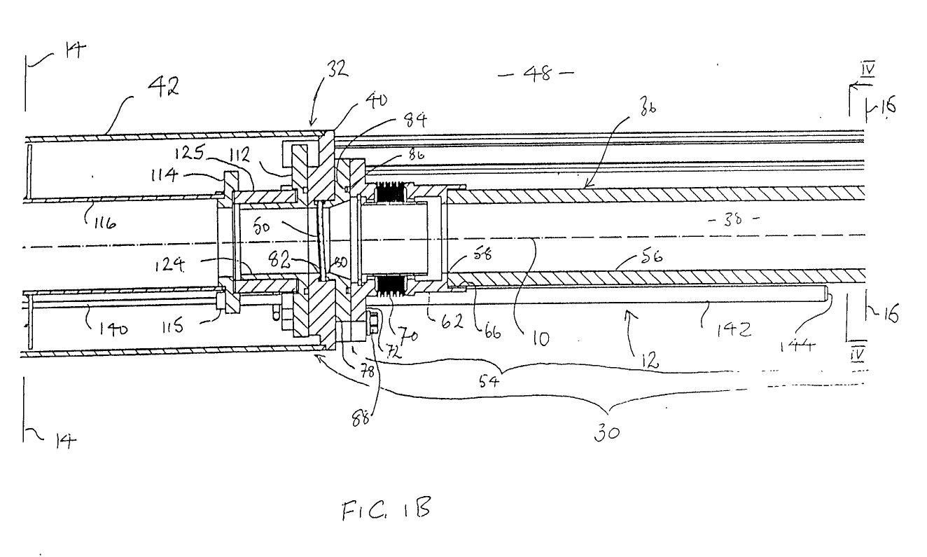

Turning now to FIGS. 1C and 3, the retroreflector arrangement at the second end 34 of the elongate hollow structure will now be described in more detail. As already mentioned, the connection flange 74 at the right-hand end of the filter support tube 64 is secured by screws 100 to the support member or flange 55 which is in turn connected via the tie members 57 to the first mounting flange 40 at the left-hand end 32 of the elongate hollow structure. As indicated in FIG. 6, the tie members 57 each have the form of an arcuate metal plate 61 with two tubes 63 and a stiffener 65 welded to it. The modular filter unit 54 can be inserted and removed through the spaces between the tie members 57 as indicated by the arrow 102. The tubes 201, 210 for the calibration gas and for the pressure sensor extend through respective ones of the tubes 63, as does the electrical lead 204 for the heater 206 associated with the retroreflector 52. This can be seen from the reference numerals 201, 210 and 204 entered in FIG. 6. The tube 201 for the calibration gas, which is also used for the neutral gas and the filter cleaning gas flow, opens via a passage 154 in the support member 55 and the orifice 154 into the optical cavity.

The support member 55 has a central opening 216 and acts at its end face 218 adjacent the central opening as a support for the open end of the retroreflector 52 which is formed in this embodiment as a corner reflector or triple reflector. If desired, a window can be provided in front of the retroreflector. The retroreflector is urged against the end face of the plate member by a compression coil spring 220 received in a pot-like recess 222 of a pressure disc or reaction member 224 which is spaced from the plate member by the ring heater 206. Three bolts 226, of which two can be seen in FIG. 3, serve to connect the pressure disc to the support member 55, with the ring heater 206 acting as a spacer. Seals 228 are provided at the two axial ends of the ring heater 206 to ensure that a sealed arrangement is present. The compression coil spring acts on the retroreflector via a cup member or piston 230 which serves to distribute the load from the spring 220 on the retroreflector. The compression coil spring 220 is a resilient member which takes account of differential thermal expansion between the retroreflector 52 and the structure 55, 206, 224, 226 surrounding it. The arrangement comprising the retroreflector, the pressure disc and the coil spring and cup member is surrounded by an outer cover 232 which is secured to the plate member via two screws 234. This cover 232, provided with seals at 236 and 238, isolates the retroreflector assembly from the gases passing through the duct 48. A further graphite seal 237 is provided between the connection flange 74 and the support member 55 in a ring groove formed in the support member.

The entire gas permeable probe can be removed as a module from the duct or chimney by releasing the bolts 49. In addition, the module comprising the transceiver 20, the housing 26, the carrier tube 178, the ring plate 184 and the third mounting flange 170 can be removed from the modular assembly comprising the second mounting flange 44, the support tube 42, the inner tube 116 and the elongate hollow structure 30 by releasing the bolts 191.

The filter module 54 comprising the connection flange 72, the flexible metallic bellows 70, the filter mounting tube 62, the filter tube member 56, the filter support tube 64 and the connection flange 74 can be removed as a unit from the gas permeable probe by releasing the screws 88 and 100 without disturbing the remainder of the assembly. Once the filter module has been removed, the pressure ring 78 can also be withdrawn axially from the first mounting flange 40 and the optical window 50 can be readily removed and exchanged as can the ring seals 83 and 87.

In addition, the module formed by the retroreflector assembly can easily be dismantled by removing the screws 234 connecting the cover 232 to the plate member and subsequently removing the screws connecting the pressure disc 224 to the support member 55 so that the retroreflector 52 and/or the ring heater 206 and the seals 228 associated therewith can be removed and replaced as necessary. The module comprising the support member 55 and the connection structure 57 as well as the first mounting plate 40 forms a welded structure which remains together as a module.

The cover of the housing 26 can be removed whenever required, thus providing access to the power supply 132 and to the other items contained in the housing.

Because the inner tube 10 is sealed in use by the optical windows 172 and 50, there is no danger of it becoming contaminated internally, and therefore there is no danger of contamination having an unpredictable effect on the light used for the spectral analysis. The conduction of the sensor line 140, the pressure sensing line 210 and the gas conducting line 201 as well as the electrical leads 128, 204 within the intermediate space between the support tube 42 and the inner tube 116 ensures that substances evaporating from these components at the elevated temperatures prevailing within the duct or chimney 48 do not contaminate the optical cavity or the interior of the inner tube 116 and therefore can also not affect the quality of the spectral analysis.

The gas permeable probe of the present invention has the following advantages and features which are united in the modular design:

A large optical absorption path.

The design permits absorption paths of 1 m for the standard design and can be made longer or shorter depending on the requirements by substituting connection structures and filter structures of different lengths which are available as exchange modules.

Integrated temperature measurement for the gas temperature.

The measurement sensor is positioned in the exhaust gases flowing through the duct or chimney and is thus protected against any corrosive substances present in the flue gases. Because of its close proximity to the filter structure, the temperature measurement is representative of the temperature prevailing in the flue or duct at the filter structure and thus in the optical cavity. Alternatively, it is also possible to place the temperature measuring sensor in the optical cavity. However, the provision of the temperature measuring sensor outside of the optical cavity facilitates the modular construction and the exchange of the filter module.

Integrated pressure measurement of the pressure in the duct or chimney.

The pressure of gas is measured in the measuring cavity and serves for the normalisation of the measurement results, especially when calibration measurements are being carried out, since then the calibration gas flowing into the cavity can be set with a higher pressure and this higher pressure must be known for the correct determination of the calibration gas values.

Gas checking is possible.

The analyzers used with the gas permeable probe and the gas permeable probe can be checked with respect to their measurement functions by using calibration gases and neutral gases to ensure that they are functioning correctly. The gas examination can take place manually or automatically. The optical cavity can be used as a neutral path by blowing the volume of the optical measurement path free of other gases using air or N₂. This can take place at any time, the gas permeable probe does not need to be removed for this purpose, the apparatus remains at its point of installation.

Use in pressurised systems is possible.

Since the optical measurement cavity is closed at one end by the optical window and at the other end by a retroreflector assembly, it can be designed for operation at elevated pressure, such as for example 2 bar. It is, however, necessary to ensure that the optical analyzer is calibrated for such pressures.

No NBR problems (Null-Punkt Reflektor=zero point reflector)

This advantage is achieved because the optical measurement path can be blown free of gases and thus filled with a neutral gas so that the zero point can be detected using the optical cavity filled with the neutral gas. It is thus possible to dispense with a separate zero point reflector. All the optical boundary surfaces which participate in the formation of the measured value are thus also involved in the zero point measurement and it is no longer possible for the measured values to be influenced by drifting of the zero point measurement.

Elimination of the sensitivity to dust

Since dust can be separated out at the surface of the filter material it no longer affects the quality of the measurement, unless the measurement is intended to detect dust particles, in which case the pore size of the filter is selected to enable the dust particles of interest to enter the optical cavity.

It can be used at high dust concentrations.

The filters in the gas permeable probe can be designed to reliably keep dust out of the optical measurement cavity (by selection of the pore size of the filter) so that it can be ensured that dust does not influence the measurement result.

No specially routed flushing air system is required.

Since dust is essentially deposited on the filter it does not reach the optical boundary surfaces. Because no permanent flushing air supply is required, there is also no possibility of the flushing air giving rise to problems, in particular with small ducts.

No problem with external light sources.

Because the beam path used for the measurement is fully encapsulated, no external light can enter into the beam path.

Utilize action with unfavourable flow conditions.

The gas permeable probe can be used, when turbulence is present and at very low gas speeds.

It can be used with pressures which change significantly.

Because no flushing air is required, the gas permeable probe cannot be affected by flushing air. In conventional systems, which require flushing air, the flushing air supply must be laid out for the maximum operating pressure and at lower operating pressures flushing air affects the measurement.

It can be used with high moisture contents.

By utitilizing filter structures with a hydrophobic membrane and small pore sizes around 0.2 μm water droplets can be kept out of the optical cavity, only gaseous water enters into the measurement cavity and this at small time constants.

Matching of the optical absorption path to the gas concentration to be measured.

The length of the measurement cavity can be matched to the gas concentration to be measured, at low concentrations along the absorption paths that are required, at high concentrations shorter absorption paths are sufficient.

Exchange of the optical components in accordance with the required spectral range (ultraviolet to infrared).

The optical components that are required, that is the windows and the retroreflector can be matched to the required spectral range by choosing suitable materials and surfaces of the components.

Crossed beam path for laser applications.

When used with a laser spectrometer the beam path in the measurement cavity is crossed, this beam guidance prevents interference effects.

Supply of calibration gases.

Calibration gases and neutral gases can be connected to gas connecting fittings and directed into the optical cavity through gas conducting lines.

Calibration gas heating.

The gas conducting line is laid out that the calibration gas or neutral gas is heated up to the temperature of the gas flow through the duct. The line leading into the optical cavity has direct contact to the exhaust gas in the duct. A body is preferably inserted into the gas conducting line which continually swirls the air (for example a bar with a spiral spring placed around it can be disposed inside the gas conducting line) and in this way the best possible contact of the gas molecules with the outer wall of the gas conducting line can be ensured. In this manner, the gas is heated up approximately to the gas temperature prevailing within the duct and the cross-section of the line can be designed such that a pressure pulse can also be effectively transmitted in order to free the outer surface of the filter from dust deposits. The gas conducting line can be the same line which serves to introduce calibration gases or neutral gases into the optical cavity or it can be a separate dedicated line.

Ceramic filters with inert behaviour can be used which have no catalytic effect on the gases to be measured.

Ceramic filters can also be used with coatings of a PTFE material in order to repel liquid water while being simultaneously permeable to gas.

Compensation for different coefficients of expansion.

This is achieved, as explained, by the use of the membrane bellows which, for example, can take account of the differential thermal expansion between the ceramic filter material and the stainless steel of the connecting structure.

Temperature range.

The temperature range can be up to and beyond 450° C. for dry applications. The temperature range can be at least up to 200° C. for wet applications. The maximum possible temperature at which the hydrophobic coating, for example the PTFE membrane, can be used is limited by the operating limit of PTFE and by the available seal materials.

Heatable optical boundary surfaces.

The use of heating for the optical boundary surfaces makes it possible to prevent these misting up when the gas permeable probe is taken to use, with intermittent operation, and at measurements close to the dew point. The optical boundary surfaces are heated to a temperature which is 55° C. higher than the local environment. From a temperature above 160° C. onwards, the heating can be switched off.

Separation of the constructional space for the guidance of leads and the optical beam path.

This separation makes it possible to avoid disturbing effects caused by foreign components. Thus contaminants on components and substances which are given off by the components are kept away from the optical cavity, so that they can not affect the measurements.

A minimum number of seal locations relative to the medium flowing through the duct or chimney.

Because only a few seal positions are present the chances of leakage is minimized.

Integrated electronics for temperature and pressure measurement and for the monitoring of the operation of the gas permeable probe.

Integrated regulation system for the heating of the optical boundary surfaces with monitoring of their operation by means of current measurements.

Output of the measurement data and input of parameters for the gas permeable probe and measurement system via a field bus.

What is claimed:

1. A gas permeable probe for use in an optical analyzer for an exhaust gas stream flowing through a duct or chimney, the probe comprising:
an elongate hollow structure having first and second ends and a side wall, with an optical cavity defined between said first and second ends within said side wall,
a mounting structure at said first end and adapted for mounting said elongate hollow structure within said duct or chimney,
an optical window at said first end permitting a beam of light originating from an optical analyzer to enter into said optical cavity to travel from said first end to said second end,
a retroreflector provided at said second end for returning said light beam to said first end of said hollow structure,
a filter structure forming a part of said side wall and including at least one filter having a pore size and adapted to permit a gas passing through said duct or chimney to enter into said optical cavity but to prevent particulate matter having particle sizes larger than said pore size from entering said optical cavity,
a bellows disposed between one of said first and second ends and said filter structure and
a connecting structure connecting said mounting structure at said first end to a support member for said retroreflector at said second end.

2. A gas permeable probe in accordance with claim 1, said optical window at said first end being adapted to transmit out of said optical cavity substantially all light returned to said first end by said retroreflector at said second end.

3. A permeable probe in accordance with claim 1, said optical window at said first end being adapted to reflect a first portion of the light returned to said first end by said retroreflector back to said retroreflector to obtain a multiple beam path within said optical cavity and to transmit a second portion of said light out of said optical cavity.

4. A gas permeable probe in accordance with claim 1, there being a reflector disposed adjacent said optical window at said first end for returning light returned by said retroreflector back to said retroreflector at least once prior to said light falling on said optical window for transmission out of said optical cavity, whereby a multiple beam path is obtained within said optical cavity.

5. A gas permeable probe in accordance with claim 1, wherein said mounting structure comprises a first mounting flange at said first end of said elongate hollow structure.

6. A gas permeable probe in accordance with claim 5, wherein said connecting structure comprises a plurality of tie members secured to said first mounting flange at said first end and to said support member at said second end.

7. A gas permeable probe in accordance with claim 5, said mounting structure further comprising a support tube connected to said mounting first flange and extending to a second mounting flange adapted for mounting to a wall of said duct or said chimney.

8. A gas permeable probe in accordance with claim 7 and further comprising an inner tube extending between said first mounting flange and said second mounting flange and defining an optical path of known characteristics between said first and second mounting flanges.

9. A gas permeable probe in accordance with claim 8, wherein said inner tube is evacuated.

10. A gas permeable probe in accordance with claim 8, wherein said inner tube contains a neutral gas or a neutral gas mixture, i.e. a gas or gas mixture which does not substantially impair a measurement carried out using said gas permeable probe.

11. A gas permeable probe in accordance with claim 5, wherein said first mounting flange is adapted for the attachment of an optical transmitter and receiver unit of an optical analyzer to said gas permeable probe.

12. A gas permeable probe in accordance with claim 7, wherein said second mounting flange is adapted for the attachment of an optical transmitter and receiver unit of an optical analyzer to said inner tube.

13. A gas permeable probe in accordance with claim 8, wherein said inner tube extends through said second mounting flange to a third mounting flange provided for the attachment of an optical transmitter and receiver unit of an optical analyzer to said gas permeable probe.

14. A gas permeable probe in accordance with claim 8 and further comprising at least one sensor line, at least one gas conducting line and at least one electrical lead, said at least one sensor line, said at least one gas conducting line and said at least one electrical lead being directed through an intermediate space formed between said support tube and said inner tube.

15. A gas permeable probe in accordance with claim 14, said at least one sensor line comprising a temperature sensing line for sensing an operating temperature in the region of said optical cavity.

16. A gas permeable probe in accordance with claim 15, wherein said temperature sensing line extends into a tube provided outside of said elongate hollow structure.

17. A gas permeable probe in accordance with claim 14, wherein said at least one sensor line comprises a pressure sensing line for sensing an operating pressure in the region of said optical cavity.

18. A gas permeable probe in accordance with claim 14, wherein said at least one gas conducting line has an outlet in said optical cavity for directing a calibration gas into said optical cavity.

19. A gas permeable probe in accordance with claim 14, wherein said at least one gas conducting line has an outlet in said optical cavity for directing a neutral gas or a neutral gas mixture into said optical cavity.

20. A gas permeable probe in accordance with claim 14, wherein said at least one gas conducting line has an outlet in said optical cavity for

20. A gas permeable probe in accordance with claim 14, wherein said at least one gas conducting line has an outlet in said optical cavity for directing pressurised gas into said optical cavity to clean said filter of particulate material adhering to an outside of said filter.

21. A gas permeable probe in accordance with claim 20, wherein said gas conducting line extends outside of said filter structure to an orifice provided in said optical cavity at said second end of said elongate hollow structure.

22. A gas permeable probe in accordance with claim 14, wherein said at least one electrical lead is connected to a heater element for said optical window.

23. A gas permeable probe in accordance with claim 14, wherein said at least one electrical lead is connected to a heater element for said retroreflector.

24. A gas permeable probe in accordance with claim 1, wherein said tubular filter structure comprises a tube of filter material having first and second ends with a filter mounting tube at said first end and a filter support tube at said second end, said filter mounting tube being connected to said bellows, said filter support tube being connected to said support member.

25. A gas permeable probe in accordance with claim 1, wherein said tube of filter material comprises one of a filter of sintered metal, a filter of sintered metal coated with a hydrophobic coating, a filter of ceramic material and a filter of ceramic material with a hydrophobic coating.

26. A gas permeable probe in accordance with claim 1, wherein said hydrophobic coating comprises PTFE.

27. A gas permeable probe in accordance with claim 18, wherein said at least one gas conducting line comprises an inbuilt structure such as a coil spring to ensure turbulence of said calibration gas and contact of said gas with an outer wall of said gas conducting line to heat said calibration gas to a temperature at least substantially equal to the temperature prevailing in said optical cavity.

28. A gas permeable probe in accordance with claim 6, there being first and second tie members arranged spaced apart to form a space between them for receiving said filter structure.

29. A gas permeable probe in accordance with claim 28, each said tie member comprising an elongate metal plate having first and second side edges and first and second tubes extending parallel to said side edges and welded thereto.

30. A gas permeable probe in accordance with claim 29, wherein said tie members are welded to said mounting structure and to said support member.

31. A gas permeable probe in accordance with claim 29, wherein at least one of a pressure sensing line, a gas conducting line and a heater lead for a heater associated with said retroreflector extend through respective ones of said tubes.

32. A gas permeable probe for use in an optical analyzer for an exhaust gas stream flowing through a duct or chimney, the probe comprising:
an elongate hollow structure having first and second ends and a side wall, with an optical cavity defined between said first and second ends within said side wall,
a mounting structure at said first end and adapted for mounting said elongate hollow structure within said duct or chimney,
a support member at said second end,
a connecting structure connecting said mounting flange at said first end to said support flange at said second end,
an optical window at said first end permitting a beam of light originating from an optical analyzer to enter into said optical cavity to travel from said first end to said second end,
a retroreflector provided at said second end for returning said light beam to said first end of said hollow structure,
an elongate filter module forming part of said elongate hollow structure, having first and second opposite ends and comprising a filter structure including at least one filter member and a bellows at one of said first and second opposite ends adjacent said filter structure,
said elongate filter module being connectable at its first end to said mounting structure and at its second end to said support member.

33. A gas permeable probe in accordance with claim 32, said mounting structure, said connecting structure and said support member forming a further module.

34. A gas permeable probe in accordance with claim 32, wherein said retroreflector, a mounting means for mounting said retroreflector on said support member and a cover are releasably mounted on a side of said support member remote from said elongate filter module.

35. A gas permeable probe in accordance with claim 32, wherein said optical window is trapped between said mounting structure and said elongate filter module by a pressure ring, said pressure ring and said optical window being removable following removal of said filter module.

36. A gas permeable probe in accordance with claim 32, having an inner tube provided within said mounting structure, said tube having first and second ends and being closed at its second end by said optical window and at its first end by a further window.

37. A gas permeable probe in accordance with claim 36, said first end of said inner tube extending beyond said mounting structure to an optical analyzer.

38. A gas permeable probe in accordance with claim 37 and further comprising a carrier tube for said optical analyzer secured to said mounting structure outside if said duct or chimney.

39. A gas permeable probe in accordance with claim 38, said carrier tube carrying a housing for equipment associated with said gas permeable probe.
